(19) United States
(12) Patent Application Publication
(10) Pub. No.: US 2021/0182972 A1
(43) Pub. Date: Jun. 17, 2021

(54) TRADING DECISION GENERATION SYSTEM AND METHOD

(71) Applicant: INDUSTRIAL TECHNOLOGY RESEARCH INSTITUTE, Hsinchu (TW)

(72) Inventors: Chi-Yuan YEH, Hsinchu City (TW); Sian-Hong HUANG, Kaohsiung City (TW); En-Tzu WANG, Fengshan City (TW); Jou-Ching LIN, Taoyuan City (TW)

(73) Assignee: INDUSTRIAL TECHNOLOGY RESEARCH INSTITUTE, Hsinchu (TW)

(21) Appl. No.: 16/717,565

(22) Filed: Dec. 17, 2019

(51) Int. Cl. G06Q 40/06; G06N 5/04; G06N 20/00; G06Q 30/02; G06F 16/23

(52) U.S. Cl. CPC G06Q 40/06; G06N 5/045; G06F 16/2365; G06Q 30/0201; G06N 20/00

(57) ABSTRACT

The present application discloses a trading decision generation system and method. The trading decision generation method includes: obtaining a market information; performing a market view generation module to generate a market view according to the market information; performing a state integration module to generate a state according to the market information, the market view and a trading information; performing a decision parameter generation module to generate a decision parameter according to the state; and performing a decision generation module to generate a decision according to the decision parameter.

### TECHNICAL FIELD

The disclosure relates to the trading decision generation system and method.

### BACKGROUND

Stock or fund investment is one of modern people's methods of financial management. Periodic investment refers to the investment of a fixed or a non-fixed amount of capital performed at specific time period (such as 1 month). Along with the development of technology, a neural network and a machine learning model are used to assist investors to make trading decisions. However, during the training process, the neural network and the machine learning model face a problem of the historic data of only one timeline, so that the market view is already known. Under such circumstances, the training process is lacking of market uncertainty, and diverse trading environment and trading scenarios. Therefore, the trading decisions outputted by the trained neural network and the trained machine learning model, despite over-fitting the historic data, are unable to respond to the changeable investment environment. Moreover, the market currently only has the trading decision generation systems that deal with periodic investment with a fixed amount of capital, but lacks the trading decision generation systems that deal with periodic investment with a non-fixed amount of capital and periodic re-investment with a non-fixed amount of capital.

### SUMMARY

An aspect of the present application discloses a trading decision generation system. The trading decision generation system includes a market view generation module, a state integration module, a decision parameter generation module and a decision generation module. The market view generation module is configured to generate a market view according to a market information. The state integration module is configured to generate a state according to the market information, the market view and a trading information. The decision parameter generation module is configured to generate a decision parameter according to the state. The decision generation module is configured to generate a decision according to the decision parameter. The market view shows whether a future price of a target will be higher or lower than a current price of the target after a specific time period in the future.

Another aspect of the present application discloses a trading decision generation method. The trading decision generation method includes: obtaining a market information; performing a market view generation module to generate a market view according to the market information; performing a state integration module to generate a state according to the market information, the market view and a trading information; performing a decision parameter generation module to generate a decision parameter according to the state; and performing a decision generation module to generate a decision according to the decision parameter. The market view shows whether a future price of a target will be higher or lower than a current price of the target after a specific time period in the future.

The above and other aspects of the invention will become better understood with regard to the following detailed description of the exemplary embodiment (s). The following description is made with reference to the accompanying drawings.

### BRIEF DESCRIPTION OF THE DRAWINGS

FIG. 1 is a block diagram of a trading decision generation system according to an embodiment of the present application.

FIG. 2 is a flowchart of a trading decision generation method according to an embodiment of the present application.

FIGS. 3A and 3B are flowcharts of a method for training a trading decision generation system according to an embodiment of the present application.

FIG. 4 is a schematic diagram of the training of a trading decision generation system according to an embodiment of the present application.

### DETAILED DESCRIPTION

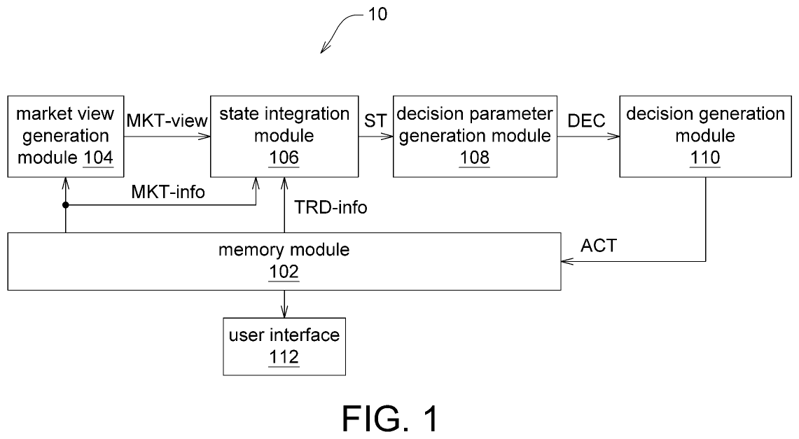

Referring to FIG. 1, FIG. 1 shows a block diagram of a trading decision generation system according to an embodiment of the present application. The trading decision generation system 10 includes a memory module 102, a market view generation module 104, a state integration module 106, a decision parameter generation module 108, a decision generation module 110 and a user interface 112. In an embodiment, the trading decision generation system 10 could be performed by a processor. Examples of the processor include central processing unit (CPU), programmable general or specific micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA) or similar elements or a combination of the above elements.

The trading decision generation system 10 is configured to generate a trading decision for automatic trading or reference according to one single target (such as a stock or a fund). In the present embodiment, the user puts a fixed amount of capital to a capital pool every one trading period. For example, the user puts 10,000 dollars to the capital pool monthly.

The memory module 102 could be realized by any fixed or movable random access memory (RAM), read-only memory (ROM), flash memory, phase change memory, hard disk drive (HDD), register, solid state drive (SSD) or similar elements or a combination of the above elements. The memory module 102 is configured to store the data necessary for the operation of the trading decision generation system 10 and the data generated during the operation.

The market view generation module 104 is coupled to the memory module 102. In an embodiment, the market view generation module 104 may access the memory module 102 to obtain a market information MKT-info from the memory module 102. In another embodiment, the market view generation module 104 receives a market information MKT-info from a source external to the trading decision generation system 10, such as a cloud database. The market information MKT-info may include the market situation at a specific time period in the past (such as past 6 months) to represent multiple feature parameters of the target, such as price trend, trading volume, technical indicators, broad market indexes, economic indicators and/or quantified financial reports. The market view generation module 104 generates a market view MKT-view according to the market information MKT-info. The market view MKT-view is a feature parameter representing whether a future price of the target will be higher or lower than a current price after a specific time period (such as 1 month). In an embodiment, the market view generation module 104 stores the market view MKT-view to the memory module 102. In an embodiment, the market view generation module 104 may predetermine multiple specific time periods and generate the market view MKT-view according to at least one selected time period. For example, short term is set as 1 month, middle term is set as 3 months, and long term is set as 6 months. The market view generation module 104 may generate the market view MKT-view for at least one of the future periods, including 1 month, 3 months and 6 months, according to the user's selection. In another embodiment, the specific time period is adjustable. For example, the market view generation module 104 may determine the specific time period according to the user's selection and may generate the market view MKT-view for the specific time period selected by the user. It is worth mentioning that the future market has uncertainty factors, that is, the market view MKT-view is a parameter with uncertainty factors, but the conventional method for generating the decision factor of the trading decision generation system is based on the fluctuations of the market prices which are already known (that is, historic data) and normally does not perform prediction on the market view.

The state integration module 106 is coupled to the market view generation module 104. The state integration module 106 is configured to receive the market information MKT-info, the market view MKT-view and a trading information TRD-info, and to generate a state ST according to the market information MKT-info, the market view MKT-view and the trading information TRD-info. In an embodiment, the state integration module 106 could be coupled to the memory module 102 to obtain the market information MKT-info, the market view MKT-view and the trading information TRD-info from the memory module 102. The trading information TRD-info may include multiple feature parameters representing currently available capital (that is, the capital in the capital pool), holding of the target, and unrealized loss or profit. The state integration module 106 may integrate the feature parameters of the market information MKT-info, the market view MKT-view and the trading information TRD-info to generate a state ST. In other words, the state ST includes the feature parameters of the market information MKT-info, the market view MKT-view and the trading information TRD-info. In an embodiment, the state integration module 106 could be coupled to the memory module 102 to store the state ST to the memory module 102.

The decision parameter generation module 108 is configured to obtain the state ST, and to generate a decision parameter DEC according to the state ST, wherein the decision parameter DEC is a real number. In an embodiment, the decision parameter generation module 108 is coupled to the state integration module 106, and obtains the state ST from the state integration module 106. In another embodiment, the decision parameter generation module 108 is coupled to the memory module 102 to obtain the state ST from the memory module 102.

The decision generation module 110 is coupled to the decision parameter generation module 108 to receive the decision parameter DEC, and generates a decision ACT according to the decision parameter DEC. In an embodiment, the decision generation module 110 could be coupled to the memory module 102 to store the decision ACT to the memory module 102. The decision ACT may include suspension, renewal, redemption, overweight, underweight and so on. “Suspension” means that no trading is performed. “Renewal” means that the capital put by the user at each trading period is invested. “Redemption” means that the holding of the target is sold in exchange for capital. “Overweight” means that an amount greater than the capital put by the user at each trading period is invested. “Underweight” means that an amount less than the capital put by the user at each trading period is invested. In an embodiment, the decision generation module 110 regards the decision parameter DEC as a unitary investment ratio a or having correlation with the unitary investment ratio a. In the present embodiment, the unitary investment ratio a is equivalent to the decision parameter DEC; in other embodiments, the unitary investment ratio a could be obtained according to the calculation of the decision parameter DEC. The decision generation module 110 may determine the decision ACT according to the relation between the unitary investment ratio a and the decision ACT as listed in Table 1.

TABLE 1

| Unitary investment ratio a | Decision ACT |
|---|---|
| 1 + r < a | Overweight: an amount of F × a (dollars) is |
| | invested |
| 1 − r ≤ a ≤ 1 + r | Renewal: an amount of F (dollars) is invested |
| 0 + r < a < 1 − r | Underweight: an amount of F × a (dollars) is |
| | invested |
| 0 − r ≤ a ≤ 0 + r | Suspension: no trading is performed |
| a < 0 − r | Redemption: an amount of F × \|a\| (dollars) is |
| | redeemed |

Wherein, F represents the capital (such as 10,000 dollars) put by the user at each trading period; r represents a tolerance (the tolerance is a real number greater or equivalent to 0, and is normally set at the training process). Generally speaking, the decision parameter DEC is a continuous value, and a tolerance is added to the decision parameter DEC such that the decision parameter DEC may correspond to a specific range. Let r be set as 0.01. When the decision parameter DEC is equivalent to 1.001, the final decision ACT could be determined as: renewing F dollars instead of overweighting 1.001*F dollars.

The user interface 112 is coupled to the memory module 102 to obtain the market view MKT-view, the trading information TRD-info and the decision ACT from the memory module 102, and to display the trading information TRD-info and the decision ACT for the user to view. For example, the user interface 112 may display information such as the current price of the target, the prediction price of the target (that is, the market view MKT-view), the amount traded (purchased or redeemed) by the user at each trading period, and the return on investment (ROI). The user interface 112 may include a graphical operation interface. The user may select or input various parameters through the graphical operation interface to generate the market view MKT-view specific time period and the tolerance and to determine whether to perform trading/investment according to the decision ACT. If the user determines not to perform trading/investment according to the decision ACT, the user may decide to perform trading by themselves through the operation of the graphical operation interface. For example, the user may set the trading amount and the units of the target to be purchased/sold. Moreover, the user interface 112 displays a trading amount each time a decision is generated by the decision generation module. When the decision is overweight or underweight, the trading amount varies with the decision parameter and a base capital (that is, the capital put to the capital pool by the user at each trading period). Unlike the conventional trading decision generation system, the trading amount performed by the trading decision system 10 at each time may flexibly vary with the decision parameter, and is not limited to the base capital or a fixed ratio of the base capital. Besides, through the user interface 112, the user may further determine whether to automatically add the gained or redeemed capital to the capital pool.

In an embodiment, the market view generation module 104 and the decision parameter generation module 108 may respectively be realized by a neural network or a machine learning model.

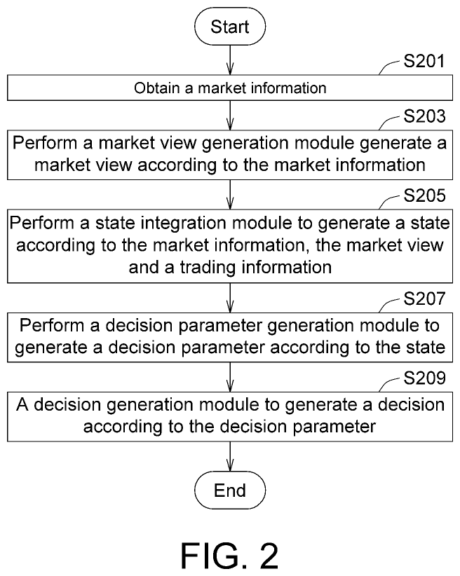

Referring to FIG. 2, FIG. 2 shows a flowchart of a trading decision generation method according to an embodiment of the present application. The trading decision generation method of the present embodiment could be performed by a processor.

In S201, a market information is obtained.

In S203, a market view generation module is performed to generate a market view according to the market information.

In S205, a state integration module is performed to generate a state according to the market information, the market view and a trading information.

In S207, a decision parameter generation module is performed to generate a decision parameter according to the state.

In S209, a decision generation module is performed to generate a decision according to the decision parameter.

Details of each step could be obtained with reference to above disclosure and are not repeated here.

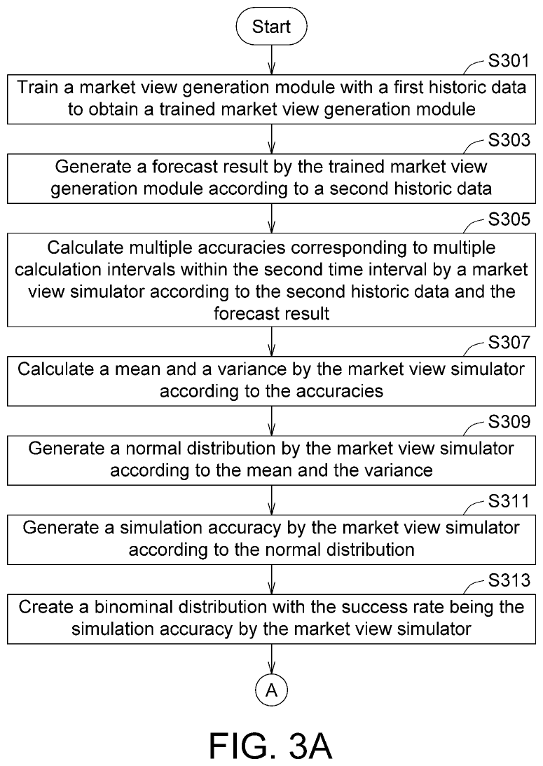

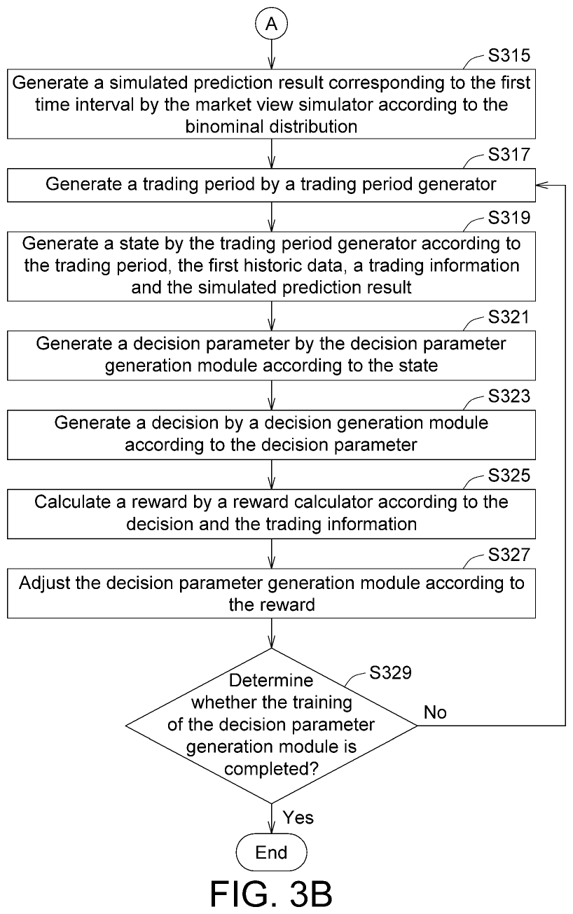

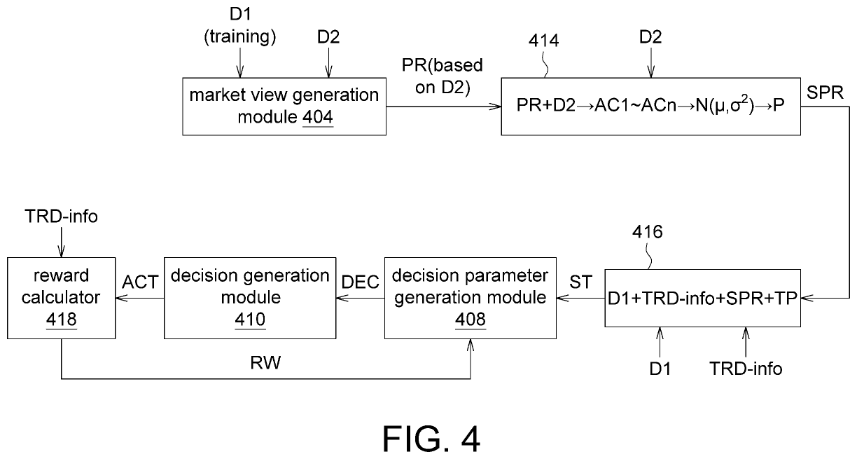

Referring to FIGS. 3A and 3B, flowcharts of a method for training a trading decision generation system according to an embodiment of the present application are shown. The market view generation module 104 and the decision parameter generation module 108 may respectively be realized by a neural network or a machine learning model. Therefore, the trading decision generation system 10 needs to be trained to enhance the market view generation module 104 and the decision parameter generation module 108. FIGS. 3A and 3B are flowcharts of a training method for training the trading decision generation system 10. In addition, referring to FIG. 4, a schematic diagram of the training of a trading decision generation system according to an embodiment of the present application is shown.

In S301, the market view generation module is trained with a first historic data D1 to obtain a trained market view generation module 404 (the trained market view generation module 404 could be used as the market view generation module 104 of the trading decision generation system 10). For example, the memory module stores the trading information corresponding to the target from 2000 to 2015. The trading information, which covers 16 years, could be divided into a first historic data D1 and a second historic data D2. The first time interval corresponds to the first historic data D1 covering 14 years of trading information from 2000 to 2013. The second time interval corresponds to the second historic data D2 covering 2 years of trading information from 2014 to 2015. The first historic data D1 is used for training the market view generation module to generate a trained market view generation module 404. The use of the second historic data D2 will be disclosed below.

In S303, a prediction result PR is generated by the trained market view generation module 404 according to a second historic data D2, wherein the prediction result PR includes multiple market views every one prediction period within the second time interval. For example, the prediction period could be 1 month. In the present example, the trained market view generation module 404 starts to generate a market view from January 2014 every 1 month from January 2014. That is, the market view generation module 404 generates a market view corresponding to January 2014, a market view corresponding to February 2014, a market view corresponding to March 2014, . . . and a market view corresponding to December 2015. As disclosed above, the market view corresponding to January 2014 represents whether the closing price of the target on the last trading day of January 2014 is higher or lower than that on the last trading day of December 2013, and the rest could be obtained by the same analogy. Additionally, the prediction period is adjustable. For example, in the training process for generating a short-term market view, the prediction period could be 1 month; in the training process for generating a middle term market view, the prediction period could be 3 months; and in the training process for generating a long-term market view, the prediction period could be 6 months.

In S305, multiple accuracies AC1˜ACn corresponding to multiple calculation intervals within the second time interval are calculated by a market view simulator 414 according to the second historic data D2 and the prediction result PR. In an embodiment, the calculation interval is fixed. The market view simulator 414 may set the calculation interval as 6 months. Firstly, accuracies are calculated according to the comparison between the prediction results (6 in total) and the second historic data D2 for the period from January 2014 to June 2014. Then, accuracies are calculated according to the comparison between the prediction results (6 in total) and the second historic data D2 for the period from February 2014 to July 2014, and the rest could be obtained by the same analogy. In another embodiment, the calculation interval is not fixed. The market view simulator 414 may randomly set the range of the calculation interval, and may calculate multiple accuracies according to the start time of the calculation interval randomly determined in the second time interval.

In S307, a mean μ and a variance σ² are calculated by the market view simulator 414 according to the accuracies AC1˜ACn.

In S309, a normal distribution N (μ,σ²) is generated by the market view simulator 414 according to the mean μ and the variance σ². The normal distribution N (μ,σ²) could be regarded as a probability distribution of prediction accuracy.

In S311, a simulation accuracy P is generated by the market view simulator 414 according to the normal distribution N (μ,σ²).

In S313, a binominal distribution with the success rate being the simulation accuracy P is created by the market view simulator 414.

In S315, a simulated prediction result corresponding to the first time interval SPR is generated by the market view simulator 414 according to the binominal distribution. The simulated prediction result SPR, trained through simulation, includes multiple simulation values of the market views corresponding to one prediction period within the first time interval. Thus, the market view simulator 414 may resolve the problem of lacking market uncertainty in the training process when the historic data is known.

In S317, a trading period TP is generated by a trading period generator 416. In an embodiment, the trading period generator 416 may randomly select an interval start time and an interval finish time to generate the trading period TP. In another embodiment, the trading period generator 416 may first decide an interval length (such as 3 years), and then decide the interval start time to generate the trading period TP. The trading period generator 416 may resolve the problem of lacking diverse trading situations in the training process.

In S319, a state ST is generated by the trading period generator 416 according to the trading period TP, the first historic data D1, a trading information TRD-info and the simulated prediction result SPR.

In S321, a decision parameter DEC is generated by the decision parameter generation module 408 according to the state ST.

In S323, a decision ACT is generated by a decision generation module 410 according to the decision parameter DEC.

In S325, a reward RW is calculated by a reward calculator 418 according to the decision ACT and the trading information TRD-info.

In S327, the decision parameter generation module 408 is adjusted according to the reward RW. For example, one or multiple parameters for implementing the neural network of the decision parameter generation module 408 are adjusted.

In S329, whether the training of the decision parameter generation module 408 is completed is determined. If the determination is affirmative, then the method terminates. If the determination is negative, then the method returns to S317. In an embodiment, the processor may determine whether the training process is completed according to whether a predetermined count is reached in steps S317-S327. In another embodiment, the processor may determine whether the training process is completed according to the decision parameter generation module 408 meets a predetermined criterion.

It should be noted that the trading period is variable during the process of repeating steps S317-S327. For example, when steps S317-S327 are performed for the first time, the trading period is from January 2010 to January 2013; when steps S317-S327 are performed for the second time, the trading period is from February 2010 to February 2013; when steps S317-S327 are performed for the third time, the trading period is from March 2010 to March 2013, and the rest could be obtained by the same analogy. Market uncertainty could be simulated by the data rolling method and the variable operation window method to avoid the first historic data D1 being over-fit by the trained decision parameter generation module 408.

In addition, when the reward calculator 418 calculates the reward RW according to the decision ACT and the trading information TRD-info, different decisions ACT may use different methods for calculating the reward. An embodiment of reward calculation is exemplified below, but the present application is not limited thereto. Firstly, a cumulative return CR is calculated according to the following formula:

CR=γRₜ₊₁+γ²(Rₜ₊₂−Rₜ₊₁)+γ³(Rₜ₊₃−Rₜ₊₂)+ . . . +γⁿ(Rₜ₊ₙ−Rₜ₊ₙ₋₁)

Wherein γ represents a decay factor,

$$0 < γ < 1 , {R}_{t + 1} = \frac{{y}_{t + 1} - {y}_{t}}{{y}_{t}} ; {R}_{t + 1}$$

represents the return at time point t+1 (t is a positive integer); yₜ represents the price of the target at time point t; and the rest could be obtained by the same analogy. The relation between the decision ACT and the reward RW could be obtained with reference to Table 2.

TABLE 2

| | Reward RW when the | Reward RW when the | |
|---|---|---|---|
| Decision ACT | holding of the target = 0 | holding of the target > 0 | |
| Overweight/ | \|a\| × (CR − tc) | \|a\| | × (CR − tc) |
| underweight/renewal | | | |
| Suspension | 0 | (1 + tf) ⁿ − 1 | |
| Redemption | −tc | \|a\| | × (−1) × CR |

Wherein tc represents a transaction cost (such as handling fee); tf represents an opportunity cost (such as term deposit rate).

It should be noted that each of the above modules, the market view simulator, the trading period generator and the reward calculator could be formed of a combination of computer readable instructions, which could be performed by a processor to implement the functions of each of the above modules, the market view simulator, the trading period generator and the reward calculator.

The above trading decision generation system obtained through training may effectively avoid the historic data being over-fit and obtaining a decision unable to tackle with diverse trading environment. Moreover, the trading decision generation system of the present application may further generate trading decisions for periodic investment with a non-fixed amount of capital and periodic re-investment with a non-fixed amount of capital. That is, the trading decision generation system of the present application may generate trading decisions for overweight and underweight in addition to renewal, suspension and redemption, and may effectively make more profit with the capital in the trading environment.

It should be noted that the trading decision generation system of the present application corresponds to a reinforcement learning (RL) architecture, wherein the market view generation module corresponds to the environment of the RL architecture, and the decision parameter generation module and the decision generation module correspond to the agent of the RL architecture.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A trading decision generation system, comprising:
a market view generation module configured to generate a market view according to a market information;
a state integration module configured to generate a state according to the market information, the market view and a trading information;
a decision parameter generation module configured to generate a decision parameter according to the state; and
a decision generation module configured to generate a decision according to the decision parameter,
wherein the market view shows whether a future price of a target will be higher or lower than a current price of the target after a specific time period in the future.

2. The trading decision generation system according to claim 1, wherein the decision generation module generates a plurality of decisions comprising renewal, suspension, redemption, overweight and underweight.

3. The trading decision generation system according to claim 1, wherein the trading decision generation system is obtained through a training using a first historic data corresponding to a first time interval, a second historic data corresponding to a second time interval, a market view simulator, a trading period generator and a reward calculator.

4. The trading decision generation system according to claim 1, wherein the trading decision generation system is trained by a training method comprising:
training the market view generation module with a first historic data corresponding to a first time interval;
generating a prediction result by a trained market view generation module according to a second historic data corresponding to a second time interval;
calculating a plurality of accuracies corresponding to a plurality of calculation intervals within the second time interval by a market view simulator according to the second historic data and the prediction result;
generating a simulated prediction result corresponding to the first time interval by the market view simulator according to the accuracies;
generating a trading period by a trading period generator;
generating a state by the trading period generator according to the trading period, the first historic data, a trading information and the simulated prediction result;
generating a decision parameter by the decision parameter generation module according to the state;
generating a decision by a decision generation module according to the decision parameter;
calculating a reward by a reward calculator according to the decision and the trading information; and
adjusting the decision parameter generation module according to the reward.

5. The trading decision generation system according to claim 4, wherein the generating a simulated prediction result corresponding to the first time interval by the market view simulator according to the accuracies further comprises:
generating a normal distribution by the market view simulator according to the accuracies, and generating the simulated prediction result according to the normal distribution.

6. The trading decision generation system according to claim 5, wherein the market view simulator generates a binominal distribution according to the normal distribution, and generates the simulated prediction result according to the binominal distribution.

7. The trading decision generation system according to claim 4, wherein the generating a simulated prediction result corresponding to the first time interval by the market view simulator according to the accuracies further comprises:
calculating a mean and a variance by the market view simulator according to the accuracies;
generating a normal distribution by the market view simulator according to the mean and the variance;
generating a simulation accuracy by the market view simulator according to the normal distribution;
creating a binominal distribution with a success rate being the simulation accuracy by the market view simulator; and
generating the simulated prediction result by the market view simulator according to the binominal distribution.

8. The trading decision generation system according to claim 4, wherein when the reward calculator calculates the reward, using different calculation methods for different decisions.

9. The trading decision generation system according to claim 1, further comprising a user interface configured to display a trading amount each time a decision is generated by the decision generation module, wherein when the decision is overweight or underweight, the trading amount varies with the decision parameter and a base capital.

10. A trading decision generation method, comprising:
obtaining a market information;
performing a market view generation module generate a market view according to the market information;
performing a state integration module to generate a state according to the market information, the market view and a trading information;
performing a decision parameter generation module to generate a decision parameter according to the state; and
performing a decision generation module to generate a decision according to the decision parameter,
wherein the market view shows whether a future price of a target will be higher or lower than a current price of the target after a specific time period in the future.

11. The trading decision generation method according to claim 10, wherein the decision generation module generates a plurality of decisions comprising renewal, suspension, redemption, overweight and underweight.

12. The trading decision generation method according to claim 10, wherein a trading decision generation system is obtained through a training using a first historic data corresponding to a first time interval, a second historic data corresponding to a second time interval, a market view simulator, a trading period generator and a reward calculator.

13. The trading decision generation method according to claim 10, wherein the decision parameter generation module is trained by a training method, comprising:
training the market view generation module with a first historic data corresponding to a first time interval;
generating a prediction result by a trained market view generation module according to a second historic data corresponding to a second time interval;
calculating a plurality of accuracies corresponding to a plurality of calculation intervals within the second time interval by a market view simulator according to the second historic data and the prediction result;
generating a simulated prediction result corresponding to the first time interval by the market view simulator according to the accuracies;
generating a trading period by a trading period generator;
generating a state by the trading period generator according to the trading period, the first historic data, a trading information and the simulated prediction result;
generating a decision parameter by the decision parameter generation module according to the state;
generating a decision by a decision generation module according to the decision parameter;
calculating a reward by a reward calculator according to the decision and the trading information; and
adjusting the decision parameter generation module according to the reward.

14. The trading decision generation method according to claim 13, wherein the generating a simulated prediction result corresponding to the first time interval by the market view simulator according to the accuracies further comprises:
generating a normal distribution by the market view simulator according to the accuracies, and generating the simulated prediction result according to the normal distribution.

15. The trading decision generation method according to claim 14, wherein the market view simulator generates a binominal distribution according to the normal distribution, and generates the simulated prediction result according to the binominal distribution.

16. The trading decision generation method according to claim 13, wherein the generating a simulated prediction result corresponding to the first time interval by the market view simulator according to the accuracies further comprises:
calculating a mean and a variance by the market view simulator according to the accuracies;
generating a normal distribution by the market view simulator according to the mean and the variance;
generating a simulation accuracy by the market view simulator according to the normal distribution;
creating a binominal distribution with a success rate being the simulation accuracy by the market view simulator; and
generating the simulated prediction result by the market view simulator according to the binominal distribution.

17. The trading decision generation method according to claim 13, wherein when the reward calculator calculates the reward, using different calculation methods for different decisions.

18. The trading decision generation method according to claim 10, further comprising:
displaying, by a user interface, a trading amount each time a decision is generated by the decision generation module, wherein when the decision is overweight or underweight, the trading amount varies with the decision parameter and a base capital.
